(19) United States
(12) Patent Application Publication
(10) Pub. No.: US 2017/0090999 A1
(43) Pub. Date: Mar. 30, 2017

(54) Storage System Multiprocessing and Mutual Exclusion in a Non-Preemptive Tasking Environment

(71) Applicant: NetApp, Inc., Sunnyvale, CA (US)

(72) Inventors: Matthew Weber, Wichita, KS (US); Douglas A. Ochsner, Wichita, KS (US); Kam Pak, Boulder, CO (US); Arindam Banerjee, Boulder, CO (US); Ben McDavitt, Wichita, KS (US); Donald R. Humlicek, Wichita, KS (US)

(21) Appl. No.: 14/866,293

(22) Filed: Sep. 25, 2015

(51) Int. Cl. G06F 9/52

(52) U.S. Cl. CPC G06F 9/528

(57) ABSTRACT

Selective multiprocessing in a non-preemptive task scheduling environment is provided. Tasks of an application are grouped based on similar functionality and/or access to common code or data structures. The grouped tasks constitute a task core group, and each task core group may be mapped to a core in a multi-core processing system. A mutual exclusion approach reduces overhead imposed on the storage controller and eliminates the risk of concurrent access. A core guard routine is used when a particular application task in a first task core group requires access to a section of code or data structure associated with a different task core group. The application task is temporarily assigned to the second task core group. The application task executes the portion of code seeking access to the section of code or data structure. Once complete, the application task is reassigned back to its original task core group.

### TECHNICAL FIELD

The present description relates to data storage and, more specifically, to systems, methods, and machine-readable media for selectively multiprocessing storage system operations to improve efficiency, memory utilization, and processor utilization.

### BACKGROUND

Conventional multi-core processors include two or more processing units integrated on an integrated circuit die or onto multiple dies in a chip package. These processing units are referred to as “CPU cores” or “cores.” The cores of a multi-core processor may all run a single OS, with the workload of the OS being divided among the cores, where any processor may work on any task so long as any one task is run by a single processor at any one time. This configuration, where the cores run the same OS, is referred to as symmetric multiprocessing (SMP).

Sometimes it is desirable to optimize a complex code base that was initially designed for single processor operation of a storage controller for multiprocessing capability. But this is a complex operation. The optimization involves adding the ability to handle the concurrency of operations on multiple CPU cores, which if not done does not necessarily impart high performance gains. The optimization requires the synchronization of critical sections of application code and/or data structures, which often includes a significant amount of overhead and can lead to CPU cache invalidations. Together, this can impair the speed at which the optimization can be brought to market.

Further, when a code base has been optimized for multiprocessing capability, the possibility arises that specific sections of the application code and/or data structures may be subject to the risk of concurrent access from multiple CPU cores. Traditional mutual exclusion approaches (such as mutexes, semaphores, and spinlocks) impart significant amounts of overhead to the operation of the storage controller, which reduces the storage controller's efficiency. Further, the complex code base may have to be significantly re-written to render the entire code base truly thread safe, which impedes the time to market.

Accordingly, the potential remains for improvements that, for example, take advantage of the gains available from multiprocessing while reducing the corresponding overhead that still ensures that critical sections of code and/or data structures would be protected from concurrent access by multiple CPU cores.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an organizational diagram of an exemplary storage controller architecture according to aspects of the present disclosure.

FIG. 3 is an organizational diagram that illustrates assignment of core groups to cores of an exemplary storage controller architecture according to aspects of the present disclosure.

FIG. 4 is an organizational diagram that illustrates an exemplary relationship between elements executed on an exemplary storage controller architecture according to aspects of the present disclosure.

FIG. 5 is a flow diagram of an exemplary method of assigning and mapping core groups to cores of an exemplary storage controller architecture according to aspects of the present disclosure.

FIG. 6 is a protocol diagram illustrating exemplary signaling aspects between first and second cores of an exemplary storage controller architecture according to aspects of the present disclosure.

FIG. 7A is a flow diagram of an exemplary method of temporarily reassigning an application task of a core group to another core group according to aspects of the present disclosure.

FIG. 7B is a flow diagram of an exemplary method of temporarily reassigning an application task of a core group to another core group according to aspects of the present disclosure.

FIG. 8 is a flow diagram of an exemplary method of initializing core groups and temporarily reassigning application tasks between core groups according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for selective multiprocessing in a non-preemptive task scheduling environment that provides a performance boost for storage controller products that have a limited time-to-market window. In an embodiment, one or more tasks of any given application may be grouped together based on a determination of similar functionality to each other and/or access to common code or data structures. The grouped tasks constitute a task core group, and each task core group may be mapped to a particular core in a multi-core processing system. A given core may have any number of task core groups mapped to it.

Since critical sections of code and data structures for a given application are also grouped and mapped to particular cores, embodiments of the present disclosure also provide for a mutual exclusion approach that reduces the amount of overhead imposed on the storage controller in implementation. As used herein, a “critical” section may refer to a portion of code that may not be concurrently executed by more than one process or thread in a multi-processing environment, for example because it attempts to access a shared resource. The task core group approach may enable running related functionality or code on pre-designated cores, since there are some service functions and routines that may need to be accessible from multiple cores. To facilitate this, a core guard method may be used that executes a core guard routine when an application task in a first task core group seeks access to a section of code or data structure associated with a different task core group (whether mapped to the same or a different core).

The application task is temporarily assigned to the second task core group, where a scheduler re-schedules the application task if the reassignment includes a different core. The application task then executes the desired portion of code that seeks access to the section of code or data structure. Once complete, the application task is reassigned back to its original task core group to resume execution as necessary and when scheduled by the scheduler.

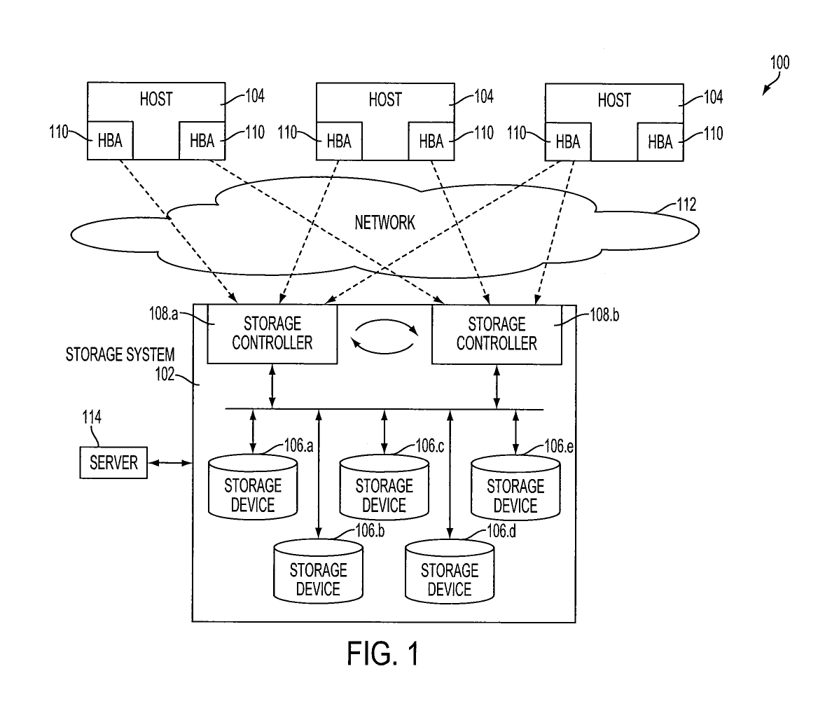

A data storage architecture 100 is described with reference to FIG. 1. In an example, the techniques to selectively multiprocess designated functionality are performed by storage controllers 108, as described in more detail below. The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to read and/or write data) from one or more of the hosts 104, and take an action such as reading, writing, or otherwise accessing the requested data. For many exemplary transactions, the storage system 102 returns a response such as requested data and/or a status indicator to the requesting host 104. It is understood that for clarity and ease of explanation, only a single storage system 102 is illustrated, although any number of hosts 104 may be in communication with any number of storage systems 102.

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor(s), cause the processor(s) to perform various operations described herein with the storage controllers 108.a, 108.b in the storage system 102 in connection with embodiments of the present disclosure. Instructions may also be referred to as code. The terms “instructions” and “code” include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor(s) may be, for example, a microprocessor, a microprocessor core, a microcontroller, an application-specific integrated circuit (ASIC), etc. According to embodiments of the present disclosure, at least one processor of one or both of the storage controllers 108.a and 108.b may include multiple CPU cores as a multi-core processor. These multiple CPU cores are configured to execute one or more application tasks that have been grouped into one or more task core groups according to aspects of the present disclosure discussed in more detail with respect subsequent figures below.

The computing system (of either the hosts 104 or the storage system 102) may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106.a, 106.b, 106.c, 106.d, and 106.e (collectively, 106) and responds to one or more hosts 104's data transactions so that the storage devices 106.a, 106.b, 106.c, 106.d, and 106.e appear to be directly connected (local) to the hosts 104. In various examples, the storage devices 106.a, 106.b, 106.c, 106.d, and 106.e include hard disk drives (HDDs), solid state drives (SSDs), optical drives, and/or any other suitable volatile or non-volatile data storage medium. In some embodiments, the storage devices 106.a, 106.b, 106.c, 106.d, and 106.e are relatively homogeneous (e.g., having the same manufacturer, model, and/or configuration). However, it is also common for the storage system 102 to include a heterogeneous set of storage devices 106.a, 106.b, 106.c, 106.d, and 106.e that includes storage devices of different media types from different manufacturers with notably different performance. The number of storage devices 106.a, 106.b, 106.c, 106.d, and 106.e are for illustration purposes only; as will be recognized, more or fewer may be included in storage system 102.

The storage system 102 may group the storage devices 106 for speed and/or redundancy using a virtualization technique such as RAID (Redundant Array of Independent/Inexpensive Disks). In an embodiment, the storage system 102 may group the storage devices 106 using a dynamic disk pool (DDP) virtualization technique. The storage system may also arrange the storage devices 106 hierarchically for improved performance by including a large pool of relatively slow storage devices and one or more caches (i.e., smaller memory pools typically utilizing faster storage media). Portions of the address space may be mapped to the cache so that transactions directed to mapped addresses can be serviced using the cache. Accordingly, the larger and slower memory pool is accessed less frequently and in the background. In an embodiment, a storage device includes HDDs, while an associated cache includes SSDs.

The storage system 102 also includes one or more storage controllers 108.a, 108.b in communication with the storage devices 106.a, 106.b, 106.c, 106.d, and 106.e and any respective caches. The storage controllers 108.a, 108.b exercise low-level control over the storage devices 106.a, 106.b, 106.c, 106.d, and 106.e in order to execute (perform) data transactions on behalf of one or more of the hosts 104. The storage system 102 may also be communicatively coupled to a user display for displaying diagnostic information, application output, and/or other suitable data. The storage controllers 108.a, 108.b are illustrative only; as will be recognized, more or fewer may be used in various embodiments.

Having at least two storage controllers 108.a, 108.b may be useful, for example, for failover and load balancing purposes in the event of equipment failure of either one. Storage system 102 tasks, such as those performed by storage controller 108.a and 108.b, may be configured to be monitored for performance statistics, such that data transactions and application and/or system tasks may be balanced among storage controllers 108.a, 108.b via load balancing techniques, as well as between CPU cores of each storage controller 108.a, 108.b. For example, for failover purposes, transactions may be routed to the CPU cores of storage controller 108.b in the event that storage controller 108.a is unavailable (and vice versa).

The storage system 102 may be communicatively coupled to server 114. The server 114 includes at least one computing system, which in turn includes a processor(s), for example as discussed above. The server 114 may include a general purpose computer or a special purpose computer and may be embodied, for instance, as a commodity server running a storage operating system. The computing system may also include a memory device such as one or more of those discussed above, a video controller, a network interface, and/or a user I/O interface coupled to one or more user I/O devices. While the server 114 is referred to as a singular entity, the server 114 may include any number of computing devices and may range from a single computing system to a system cluster of any size.

In an embodiment, the server 114 may also provide data transactions to the storage system 102. Further, the server 114 may be used to configure various aspects of the storage system 102, for example under the direction and input of a user. In some examples, configuration is performed via a user interface, which is presented locally or remotely to a user. In other examples, configuration is performed dynamically by the server 114. Some configuration aspects may include the definition of RAID group(s), disk pool(s), and volume(s), to name just a few examples.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108.a and/or 108.b of the storage system 102. The HBA 110 provides an interface for communicating with the storage controller 108.a and/or 108.b, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire.

The HBAs 110 of the hosts 104 may be coupled to the storage system 102 by a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), a Storage Attached Network (SAN), the Internet, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., read, write, modify, etc.) remote data, a host HBA 110 sends one or more data transactions to the storage system 102. Data transactions are requests to read, write, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by reading, writing, or otherwise accessing data on the relevant storage devices 106.a, 106.b, 106.c, 106.d, and 106.e. A storage system 102 may also execute data transactions based on applications running on the storage system 102 using the storage devices 106.a, 106.b, 106.c, 106.d, and 106.e. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106.a, 106.b, 106.c, 106.d, and 106.e. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a Wide Area Network (WAN), and/or a Local Area Network (LAN). Fibre Channel and FCoE are well suited for embodiments where hosts 104 are coupled to the storage system 102 via a direct connection or via Fibre Channel switches. A SAN device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. It is understood that the scope of present disclosure is not limited to either block-level or file-level protocols, and in many embodiments, the storage system 102 is responsive to a number of different memory transaction protocols.

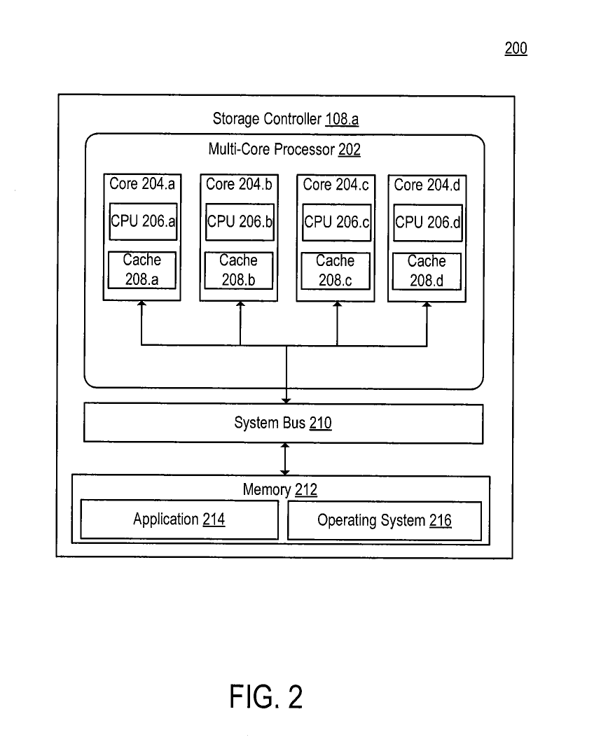

FIG. 2 is an organizational diagram of an exemplary storage controller architecture 200 according to aspects of the present disclosure. For example, the storage controller architecture 200 may be exemplary of either or both of storage controllers 108.a and 108.b of FIG. 1. Reference will be made to storage controller 108.a herein for simplicity.

As shown in FIG. 2, the storage controller 108.a includes a multi-core processor 202. The multi-core processor 202 may include a microprocessor, a plurality of microprocessor cores, a microcontroller, an application-specific integrated circuit (ASIC), a central processing unit (CPU), a digital signal processor (DSP), a controller, a field programmable gate array (FPGA) device, another hardware device, a firmware device, or any combination thereof. In the present example, as shown in the illustration, the multi-core processor 202 includes multiple cores 204.a, 204.b, 204.c, 204.d. The term multi-core processor includes any processor, such as a dual-core processor, that includes two or more cores. The number of cores illustrated in FIG. 2 is for example only; as will be recognized, fewer (e.g., two) or more (e.g., six, eight, ten, or more) cores 204 may be included without departing from the scope of the present disclosure. The multi-core processor 202 may also be implemented as a combination of computing devices (e.g., several multi-core processors, a plurality of microprocessors, one or more microprocessors in conjunction with a multi-core processor, or any other such configuration).

While the multi-core processor 202 is referred to as a singular entity, the storage controller 108.a may include any number of multi-core processors, which may include any number of cores. For example, storage controller 108.a may include several multi-core processors, each multi-core processor having a plurality of cores.

In the present example, the cores 204.a, 204.b, 204.c, 204.d each include independent CPUs 206—core 204.a includes CPU 206.a, core 204.b includes CPU 206.b, core 204.c includes CPU 206.c, and core 204.d includes CPU 206.d. Further, as illustrated in FIG. 2 each core 204 includes a cache 208—core 204.a includes cache 208.a, core 204.b includes cache 208.b, core 204.c includes cache 208.c, and core 204.d includes cache 208. The caches 208 may be, for example, L1 cache. Further, in some examples, cores 204.a, 204.b, 204.c, 204.d may share one or more caches (e.g., an L2 cache). The cores 204 may be integrated into a single integrated circuit die or into multiple dies of a single chip package, as will be recognized.

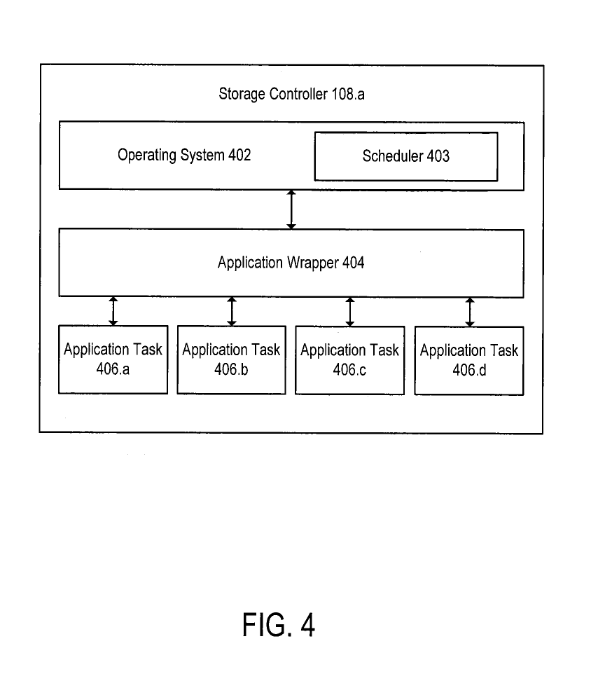

The multi-core processor 202 may be coupled to a memory 212 via a system bus 210. One or more intermediary components, such as shared and/or individual memories (including buffers and/or caches) may be coupled between the cores 204.a, 204.b, 204.c, 204.d and the memory 212. Memory 212 may include DRAM, HDDs, SSDs, optical drives, and/or any other suitable volatile or non-volatile data storage media. Memory 212 may include an operating system 216 (e.g., VxWorks, LINUX, UNIX, OS X, WINDOWS) and at least one application 214, which includes instructions that are executed by the multi-core processor 202. For example, the operating system 216 may run system tasks to perform different functions like I/O scheduling, event handling, device discovery, peering, health checks, etc. According to embodiments of the present disclosure, reference to the operating system 216 may also refer to an application wrapper that sits between the operating system and tasks of one or more applications, as discussed in more detail below with respect to FIG. 4.

Multi-core processor 202 executes instructions of the application 214 and/or operating system 216 to perform operations of the storage controller 108.a, including processing transactions initiated by hosts (e.g., hosts 104, server 114, or other devices within storage system 102). In the present example, application 214 includes one or more tasks that are assigned to one or more cores 204.a-204.d. These may be non-preemptive tasks, e.g., each task completes a given set of operations before allowing another task to run. This may also be referred to as voluntary preemption. In an embodiment, though non-preemptive amongst each other, the application tasks may still be preempted by system tasks, such as those originating from the operating system 216. There may be any number of applications 214 stored and/or running at any given time at the storage controller 108.a. The application 214 may be run on top of the operating system 216. In some examples, the storage controller 108.a may implement multiprocessing after an initialization process (e.g., after initializing an operating system or a particular application).

Each core 204.a, 204.b, 204.c, and 204.d may be configured to execute one or more application and/or system tasks (e.g., from the application 214 and the operating system 216, respectively). A task may include any unit of execution. Tasks may include, for example, threads, processes and/or applications executed by the storage controller 108.a. In some examples, a task may be a particular transaction that is executed on behalf of a host such as querying data, retrieving data, uploading data, and so forth. Tasks may also include portions of a transaction. For example, a query of a data store may involve sub-parts that are each a separate task. The particular core assigned to the task executes the instructions corresponding to the task according to embodiments of the present disclosure.

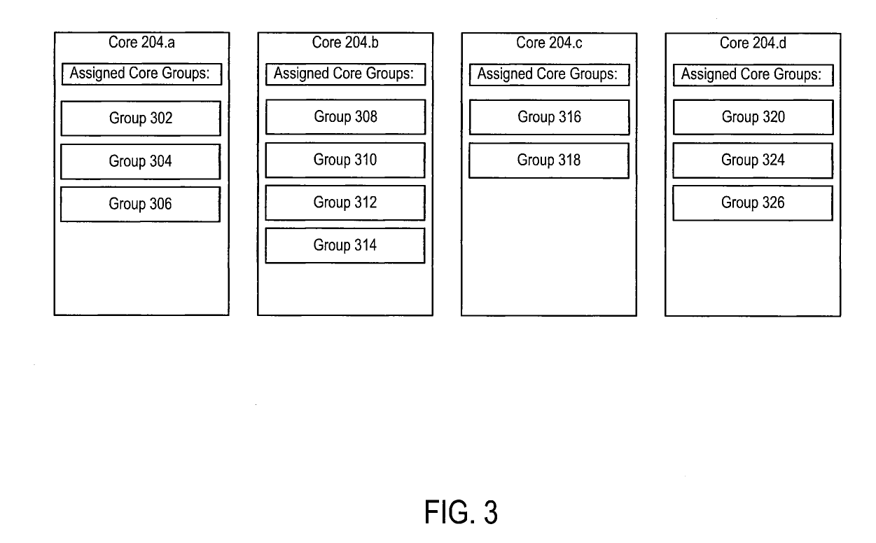

The application 214 and the operating system 216 may each be broken down into a discrete amount of tasks. For example, an application 214 may be broken down into multiple tasks based on their similarity to each other, referred to herein as task core groups, and as illustrated in FIG. 3.

FIG. 3 is an organizational diagram that illustrates assignment of tasks to task core groups, and of task core groups to cores, of an exemplary storage controller architecture according to aspects of the present disclosure. Reference will still be made to storage controller 108.a for simplicity of discussion, as introduced above with respect to FIGS. 1 and 2. Continuing with the example of FIG. 2 specifically, the storage controller 108.a is illustrated in FIG. 3 with four cores 204.a through 204.d. Each core 204.a through 204.d has one or more task core groups assigned to them. The task core groups may include different tasks that have been classified together. For example, tasks of an application, such as application 214 of FIG. 2, may be deemed to be related to each other in the sense that the different tasks perform similar functionality to each other and/or can access common code or data structures. The determination of what tasks are related to each other, and the act of identifying the tasks into common groupings, may be performed prior to operation, e.g. by a user.

For example, tasks that manage the RAID operations or the data cache management operations within the storage controller 108.a may be classified into a single task core group and called the RAIDCache task core group. The RAIDCache task core group may include tasks that manage I/O transactions as well as tasks that perform volume management operations, disk pool management, volume failover and other control path operations. These are logically related and mostly operate on common data structures.

Other tasks may manage low level protocol operations within the storage controller 108.a (e.g. iSCSI, Fibre Channel, SAS, etc.) and may be classified into separate task core groups. Tasks that perform I/O transactions using the Fibre Channel protocol may be classified into a separate task core group from tasks that perform transactions using the SAS protocol, and similarly with respect to iSCSI and IB. These task core groups may include tasks that perform read/write operations in response to I/O transactions as well as tasks that perform device discovery operations that can be initiated either by a host (e.g., host 104) or initiated by the storage controller 108.a itself. Discovery of devices and read/write I/O handling to those devices at the protocol level may operate on similar sets of data structures. These are just a few examples for purposes of illustration.

As illustrated in FIG. 3, core 204.a may have task core groups 302, 304, and 306 assigned to it, core 204.b may have task core groups 308, 310, 312, and 314 assigned to it, core 204.c may have task core groups 316 and 318 assigned to it, and core 204.d may have task core groups 320, 324, and 326 assigned to it. These are exemplary only; as will be recognized, a given core may have any number of task core groups assigned to it. Some examples of the types of task core groups available to be assigned to a given core include “core_group_base,” “raid/cache,” core_group_fc.” “core_group_ib,” “SAS,” “iSCSI,” “high level driver,” and “compression.” As will be recognized, these are exemplary only—there may be fewer or more than the above listed, and each may be assigned to any given core. Each group may have one or more tasks related to the general topic of the group.

As the examples above demonstrate, more than one application may have tasks distributed to one or more cores. As a result of the grouping of potentially related tasks together (from either one application 214 or multiple applications 214) into task core groups that are assigned to specific cores, data structures (associated with tasks in a given task core group) receive additional protection by remaining accessible only by a specific core.

Turning now to FIG. 4, an organizational diagram is provided that illustrates an exemplary relationship between elements executed on an exemplary storage controller architecture according to aspects of the present disclosure. Reference will be made to storage controller 108.a for simplicity of discussion, as introduced above with respect to FIGS. 1, 2, and 3.

In particular, FIG. 4 illustrates a relationship between different application tasks for one or more applications 214 in storage controller 108.a. Shown is an operating system 402, including a scheduler 403, an application wrapper 404, and application tasks 406. FIG. 4 illustrates application tasks 406.a, 406.b, 406.c, and 406.d, on a task assigned to each core illustrated in FIG. 2. This is for ease of illustration, as it will be recognized that a task may not be executing on each core at the same time. The operating system 402 may be as discussed above with respect to operating system 216 in FIG. 2. The operating system 402 may include a scheduler 403, which embodiments of the present disclosure utilize in scheduling different tasks of the different task core groups amongst each other and the cores.

The application wrapper 404 may operate between the operating system 402 and the application tasks 406 of one or more applications. The application wrapper 404 may provide a layer between the operating system 402 and the application tasks 406 that operates to map task core group assignments to physical cores, such as to implement the assignments shown in FIG. 3 and discussed above. For example, one or more cores may execute an application that determines the assignments of task core groups to different cores maintained with the application tasks. The application wrapper 404 may keep track of the different task core groups. Whenever a task core group change may become desired for a given application task 406, e.g. to enable access to a data structure under the control of another task core group (either at the same core or a different core), the application wrapper 404 may receive the request to change task core groups, determine whether the request includes reassignment to a different core or not, and temporarily reassign to a different task core group (and core, where applicable) according to the core guard procedure that will be described with respect to the other figures below.

In an embodiment, the application wrapper 404 may also, as part of tracking the different task core groups, monitor core resource utilization and reassign task core groups, in total, to different cores (e.g., referring to FIG. 3, where the application wrapper 404 observes that core 204.b may be overloaded while task core group 204.c is not, may automatically reassign a task core group from core 204.b, e.g. group 314, to core 204.c).

The application wrapper 404 is illustrated as a separate entity from the operating system 402, however, in an embodiment the application wrapper 404 may be included as a part of the operating system 402. In another embodiment, the application wrapper 404 may be a separate application from the operating system 402 and any application 214. In another embodiment, the application wrapper 404 may itself be a segment of an application 214 that also provides other functionality, such as an application 214 that has one or more tasks grouped into one or more of the task core groups discussed above for FIG. 3.

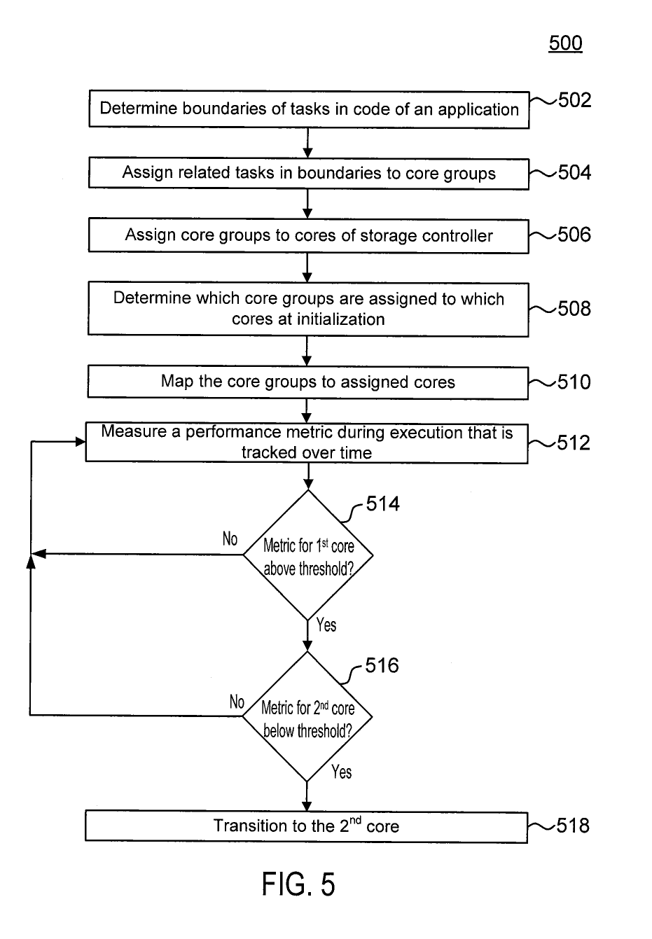

FIG. 5 is a flow diagram of an exemplary method 500 of assigning and mapping task core groups to cores of an exemplary storage controller architecture according to aspects of the present disclosure. In an embodiment, the method 500 may be implemented by the storage controller 108 executing computer-readable instructions to perform the functions described herein in cooperation the rest of the storage system 102. It is understood that additional steps can be provided before, during, and after the steps of method 500, and that some of the steps described can be replaced or eliminated for other embodiments of the method 500.

At block 502, one or more boundaries between types of tasks within the code of an application, such tasks 406 of an application 214, are determined. Boundaries, as used here, may refer to areas of code (e.g., the different tasks) within an application that may clearly be delineated between different categories of functionality and/or data structures to which the areas of code will or could access during execution. These boundaries may be determined, for example, by a user before the application is executed, pre-designated at compile time or designated by one or more cores in a storage controller 108.

At block 504, the tasks that are related to each other within the determined boundaries from block 502 are assigned to common task core groups. Each task core group may include multiple tasks, and may exhibit similar traits or data access requirements.

At block 506, the different task core groups are assigned to the different cores of a given controller. As this may be performed beforehand by a user or pre-designated during compile time, there may be different levels of assignment performed, so as to address a variety of different types of controllers on which the application may operate (e.g., controllers with dual cores, quad cores, or more).

At block 508, when a storage controller 108 is initialized (e.g., by a single core or multiple cores of the processor 202), the storage controller 108 determines the cores that the different task core groups are assigned to. As will be recognized, this could include task core groups all related to a single application 214 or multiple applications 214.

At block 510, the storage controller 108 maps the task core groups to their assigned cores according to the result of the determination from block 508. This may include, for example, the storage controller 108 may maintain a listing of task core groups and the cores to which they have been mapped.

At block 512, the storage controller 108 measures one or more performance metrics for each of the cores of processor 202 that have task core groups assigned to them (and, where there are one or more cores with no groups assigned to them that are available for task core groups, those as well). Performance metrics may include CPU utilization, speed of execution, size of delays, etc. of the different cores of the processor 202.

At decision block 514, the storage controller 108 compares the measured performance information of a first core against a first threshold to determine whether the performance metric(s) exceed the first threshold. The comparison may be of a single metric, of all metrics, and/or a weighted combination of the different metrics against corresponding thresholds for each metric. The threshold may be a generic threshold (e.g., common to each core), or a specific threshold unique to the characteristics of the specific core.

If the storage controller 108 determines that the measured performance information does not exceed the first threshold, then the method 500 may return to block 512 to continue monitoring. If the storage controller 108 determines that the measured performance information exceeds the first threshold, then the method 500 proceeds to decision block 516.

At decision block 516, the storage controller 108 compares the measured performance information of a second core against a second threshold to determine whether the performance metric(s) for the second core fall below the second threshold. The comparison may be of a single metric, of all metrics, and/or a weighted combination of the different metrics against corresponding thresholds for each metric. The threshold may be a generic threshold (e.g., common to each core), or a specific threshold unique to the characteristics of the specific core. The second threshold may be different from the first threshold (e.g., lower), or the first and second thresholds may be the same. The determinations at decision blocks 514 and 516 may be repeated for every core where there are more than two, as will be recognized.

If the storage controller 108 determines that the measured performance information for the second core does not fall below the second threshold, then the method 500 may return to block 512 to continue monitoring. This corresponds to a situation where the first core could give up one or more task core groups to better balance processing load, but no other core is available to accept the additional burden. If, instead, the storage controller 108 determines that the measured performance information falls below the second threshold, then the method 500 proceeds to block 518.

At block 518, the storage controller 108 (for example, by way of the application wrapper 404) may transition one or more task core groups to the second core that has additional capacity. This process of assessing the performance metrics of the different cores may continue over time, with task core groups occasionally being remapped to different cores during operation to better balance processing burden among the cores as determined useful. This may include the storage controller 108 updating the listing of task core groups and the cores to which they have been mapped to reflect the remapping. As a result of the above and a non-preemptive tasking model, critical sections of code and data structures for functional areas of code that are grouped together (into task core groups) may be protected from concurrent access since they execute on the same core. Running related functionality on the same core and doing appropriate batch processing may improve the possibility of improved CPU cache utilization.

As described above, according to aspects of the present disclosure related functionality and pieces of code (tasks) are grouped together and execute on the same core. Certain data structures and sections of code remain, however, that could be accessed concurrently by different cores executing different tasks and thus still may benefit from protection against concurrent access by multiple cores. Although an entire code base could theoretically be made fully thread safe, this would likely require a significant rewrite of the entire code base for existing applications, which is time-consuming and potentially error-prone, slowing down time to market. Further, traditional mutual exclusion methods (e.g., mutexes, semaphores, and spinlocks) impart significant amounts of overhead for several scenarios (especially when executing kernel-critical sections). Embodiments of the present disclosure provide an approach that is simpler in scope of code changes, more efficient (less overhead), and easily testable, referred to herein as a Core Guard.

As a result of the aspects described above, e.g. with respect to FIG. 5, designated pieces of code, the tasks, are executed by mapped cores. As a result, data structures are also accessed only by a given core. In an embodiment, data structures may be assigned to a given core based on a related task that may have primary responsibility for that data structure. In another embodiment, the data structures may be assigned to certain cores independent from tasks that may be assigned to the given core. Normally, when a given data structure needs to be accessed from multiple tasks, those multiple tasks have already been grouped together into a common task core group so that they are always run on the same core as each other.

Since the tasks are non-preemptive (e.g., the task scheduling model is non-preemptive), a task voluntarily relinquishes its assigned core during execution for other application tasks and does not relinquish until it has completed execution. Voluntary preemption may therefore ensure that no data structures are left in an inconsistent state when task switching occurs on a given core. In an embodiment, application tasks may still be preempted involuntarily by system tasks, but normally a concern about inconsistent data structure state may not arise because system and application tasks typically do not attempt to access/change the same data structures.

Given the sheer size of the typical storage controller firmware code base, and the varying levels of functionalities that the code base normally performs, certain sections of code and data structures may be reused by different tasks running on different cores (in other words, even after similar tasks have been grouped into common task core groups for a specific core). For example, several different service routines, counters, and statistics may be used globally across many different components on the same or different cores. Access to common code, data structures, state information, global counters, and statistics may still be made mutually exclusive according to embodiments of the present disclosure by the implementation of the core guard. The core guard ensures that these critical sections of code or data structures still remain accessible by a given core, eliminating access by other cores. To access the critical section of code/data structure, a task may either be assigned to the same task core group as the section of code/data structure, or seek temporary reassignment or rescheduling to that core/task core group in a mutually exclusive manner as discussed below.

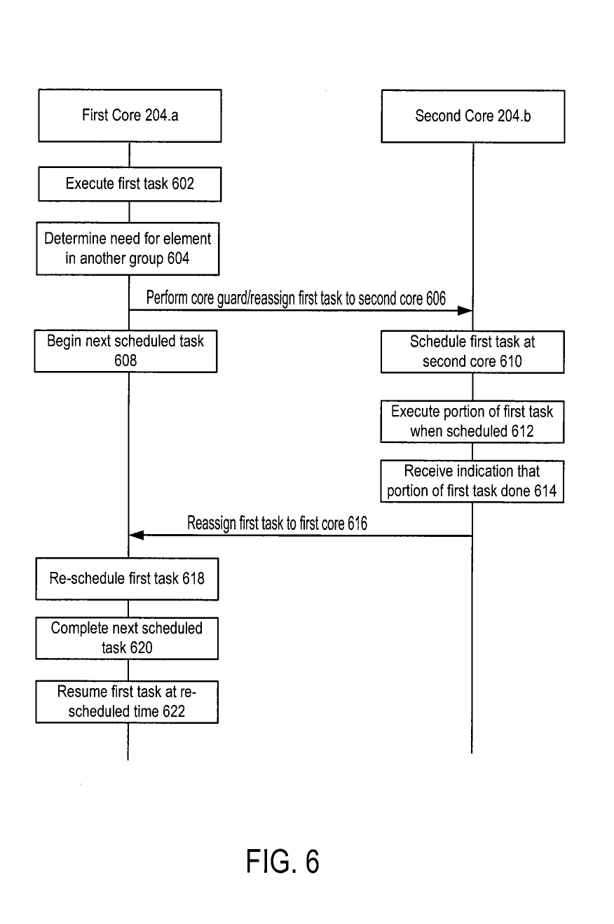

FIG. 6 is a protocol diagram illustrating exemplary signaling aspects between first and second cores of an exemplary storage controller architecture according to aspects of the present disclosure that implement the core guard. For simplicity of discussion, reference will be made to the elements shown in FIGS. 1, 2, 3, and 4 (e.g., storage controller 108, processor 202, cores 204 of processor 202, task core groups 302-326, scheduler 403, application wrapper 404, and application tasks 406) in describing the actions in the protocol diagram of FIG. 6, using cores 204.a and 204.b for example. Further for simplicity, discussion will focus on those aspects of the protocol flow that describe aspects of embodiments of the present disclosure instead of all aspects of an attach procedure.

At action 602, a first core 204.a executes a first application task (e.g., 406.a of FIG. 4). The first application task is part of a task core group assigned to the first core 204.a.

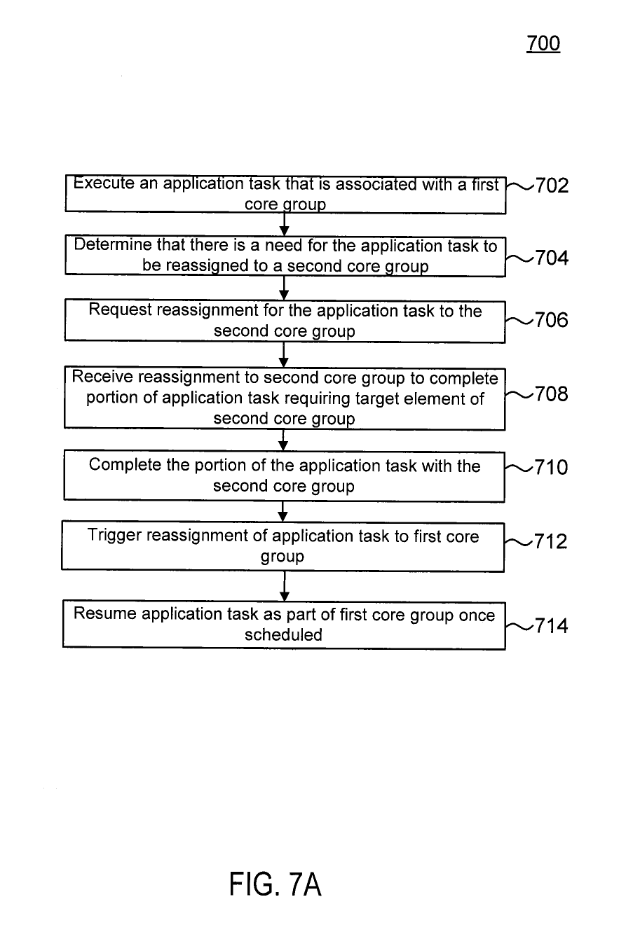

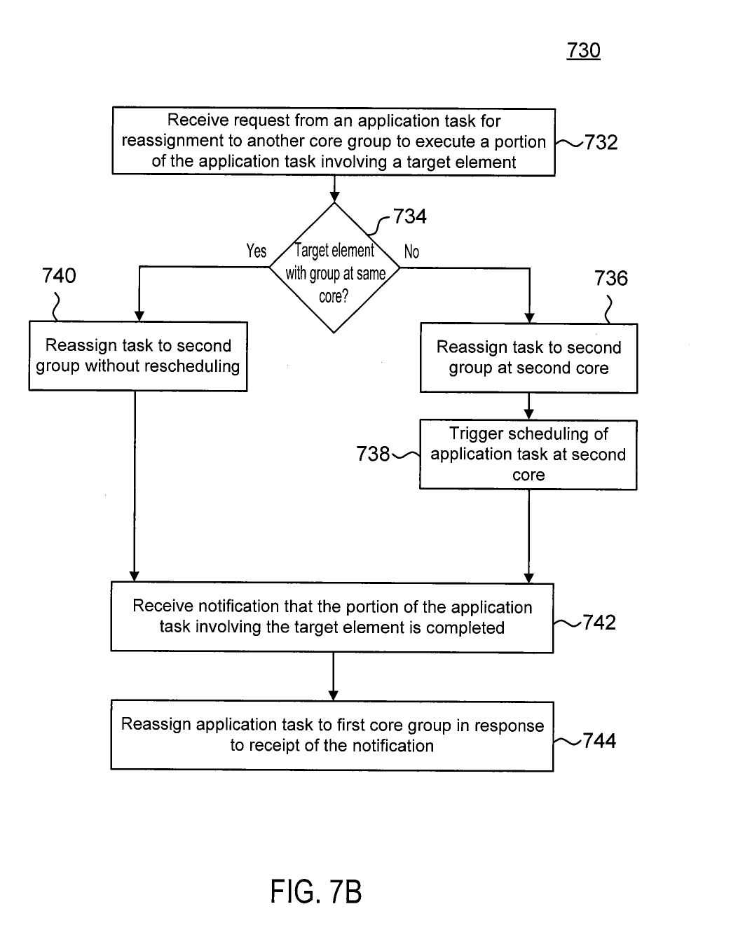

At action 604, during execution of the first application task the first core 204.a determines, or is informed by the first application task, that the first application task has a need to access and/or manipulate an element (such a as a piece of code or other data structure) that is associated with a task core group different from the first application task's task core group. For example, the first application task currently executing may call a particular function that notifies the application wrapper 404 (of FIG. 4) that a switch to a different core is requested. As illustrated in more detail with respect to FIG. 7B, the different task core group may either be another task core group assigned (mapped) to the same first core 204.a, or another core (e.g., 204.b). In the example of FIG. 6, it is determined that the task core group with which the desired element is associated is mapped to a different core, second core 204.b.

At action 606, a core guard process is executed by which the first application task is momentarily reassigned or rescheduled to the second core 204.b. In particular, according to the core guard process the first application task may be reassigned to a specific task core group that is mapped to the second core 204.b, the specific task core group having access to the element (e.g., data structure) that the first application task is seeking to access and/or modify. This may be done, for example, by the application wrapper 404 receiving a request for access to an element (e.g., data structure) that is part of a different task core group. The task core group where the first application task is executing may not know exactly what other task core group the desired element is associated with, instead relying on the application wrapper 404 to identify where the core guard operation should occur.

At action 608, as the first application task is reassigned temporarily to the second core 204.b, the first core 204.a (e.g., in accordance with a scheduler such as scheduler 403) begins a next, second scheduled task. Thus, the first core 204.a is not kept idle while the temporarily reassigned first application task is associated with another core.

At action 610, the first application task has been temporarily reassigned to the task core group at second core 204.b where the element is mapped, and a scheduler (such as scheduler 403 of the operating system 402) schedules the reassigned first application task amongst any other tasks at the second core 204.b. As an example, where another application task is currently executing at the second core 204.b, the scheduler may schedule the reassigned first application task to execute at the second core 204.b at some future point in time after the non-preemptive task(s) at the second core 204.b has finished execution.

At action 612, the reassigned first application task reaches its scheduled turn at the second core 204.b and executes that portion of the first application task that requires access to the element (e.g., data structure).

At action 614, the application wrapper 404 may receive an indication that the portion of the reassigned first application task requiring access to the element has finished execution at the second core 204.b. The indication may be an implicit indication (e.g., the portion of code requiring access to the element goes out of scope) or explicit (e.g., calling another function that notifies the application wrapper 404 to revert the assignment back to the original task core group at the first core 204.a).

At action 616, the first application task is reassigned to its original task core group at the first core 204.a. For example, the application wrapper 404 may handle the reassignment to the original task core group.

At action 618, in response to the reassignment the scheduler reschedules the first application task at the first core 204.a.

At action 620, the scheduled task at first core 204.a completes execution. As noted above with respect to action 608, another, second task that had been scheduled and began execution (and/or some subsequent task(s) scheduled at the first core 204.a) may still be executing, in which case the first application task is scheduled for a subsequent cycle so that the current task (or tasks) may complete according to voluntary preemption.

At action 622, the first application task resumes execution at its scheduled time and proceeds, according to voluntary preemption, until it completes and another scheduled task may begin.

As a result of the above core guard operations, a task's task core group is temporarily altered so that it may be mapped to a given core where the critical section of code/data structure is also mapped. The non-preemptive task scheduling model according to embodiments of the present disclosure ensures that no other task running on the core associated with the critical section of code/data structure preempts the reassigned task as it accesses the critical section of code/data structure.

Turning now to FIG. 7A, is a flow diagram of an exemplary method 700 of an application task executing on a core, temporarily being reassigned to another task core group, and resuming execution as part of the application task's original task core group according to aspects of the present disclosure. The method 700 may be implemented by the storage controller 108 executing computer-readable instructions to perform the functions described herein in cooperation the rest of the storage system 102, for example one or more application tasks as discussed above with respect to FIG. 4. A single application task is described for simplicity of illustration of the principles herein. It is understood that additional steps can be provided before, during, and after the steps of method 700, and that some of the steps described can be replaced or eliminated for other embodiments of the method 700.

At block 702, the application task is executed at a first core to which a first task core group (the task core group to which the application task is originally assigned, such as described above with respect to FIG. 5) is mapped.

At block 704, the application task determines that it needs to be temporarily reassigned to a second task core group different from the first task core group, for example because access is desired to an element (e.g., data structure) that is associated with the second task core group.

At block 706, the application task requests temporary reassignment from the first task core group to the second task core group, for example via a function call to the application wrapper 404.

At block 708, the application task is reassigned to the second task core group by the application wrapper 404 in order to complete that portion of the application task that requires access to the element (such as critical section of code/data structure) that is associated with the second task core group. According to embodiments of the present disclosure, that second task core group may be mapped to the same core as the first task core group or a second core. As part of this reassignment, a scheduler may schedule the application task at the core to which the second task core group is mapped.

At block 710, the application task (once scheduled), executes that portion of the application task that requires the access and completes the portion.

At block 712, the application task triggers reassignment back to the first task core group to continue execution (then or at some subsequent point in time) once rescheduled as part of the first task core group. The trigger may be, for example, the implicit or explicit indication as described above with respect to action 614 of FIG. 6.

At block 714, the application task resumes execution when scheduled as part of the first task core group. The above method may continue as applicable for the same application task and any other application tasks at any of the cores of the processor 202 (FIG. 2) of a storage controller 108, according to embodiments of the present disclosure.

FIG. 7B is a flow diagram of an exemplary method 730 of temporarily reassigning an application task of a task core group to another task core group according to aspects of the present disclosure. The method 730 may be implemented by the storage controller 108 executing computer-readable instructions to perform the functions described herein in cooperation the rest of the storage system 102, for example the application wrapper 404 as discussed above with respect to FIG. 4. Interaction with a single application task is described for simplicity of illustration of the principles herein. It is understood that additional steps can be provided before, during, and after the steps of method 730, and that some of the steps described can be replaced or eliminated for other embodiments of the method 730.

At block 732, the application wrapper 404 receives a request from the application task assigned to a first task core group on a first core for reassignment to a second task core group in order to execute a portion of the application task that requires access to an element (e.g., critical section of code/data structure) that has been grouped with the second task core group. This may be the result of a function call, for example, by the application task. From the perspective of the application task, it may not know what second task core group exactly is desired, but rather only that the second task core group is some group different from the first task core group. In an alternative embodiment, the application task may include as part of its request an identification of the second task core group.

At decision block 734, the application wrapper 404 determines whether the target element is grouped with a second task core group that has been mapped to the same core as the first task core group. If the second task core group has not been mapped to the same core, then the method 730 proceeds to block 736.

At block 736, the application wrapper 404 reassigns the application task to the second task core group mapped to the second core.

At block 738, the application wrapper 404's reassignment of the application task to the second task core group mapped to the second core triggers a scheduler of the storage controller 108 to schedule the application task at the second core where appropriate.

Returning to decision block 734, if the application wrapper 404 instead determines that the second task core group has been mapped to the same core as the first task core group, then the method 730 proceeds to block 740.

At block 740, the application wrapper 404 reassigns the application task to the second task core group at the same core as the first task core group. As a result, in this alternative the application wrapper 404 does not trigger a scheduler (such as scheduler 403) to reschedule the application task at the first core—it merely continues execution albeit as a member of the second task core group instead of the first task core group while accessing the target element (e.g., critical section of code/data structure).

The method 730 proceeds to block 742 from both blocks 738 and 740. At block 742, the application wrapper 404 receives notification that the portion of the application task requiring access to the target element has completed. The notification may be explicit or implicit, as described above with respect to action 614 of FIG. 6.

At block 744, the application wrapper reassigns the application task to the first task core group in response to receiving the notification at block 742. The application task may then resume execution as part of the first task core group (which would involve rescheduling as well where a second core was involved).

With respect to the methods 700 and 730 described above, according to embodiments of the present disclosure there may be multiple core guards in operation at any given time, for example as between cores as well as a given application task recursively calling multiple core guards where applicable.

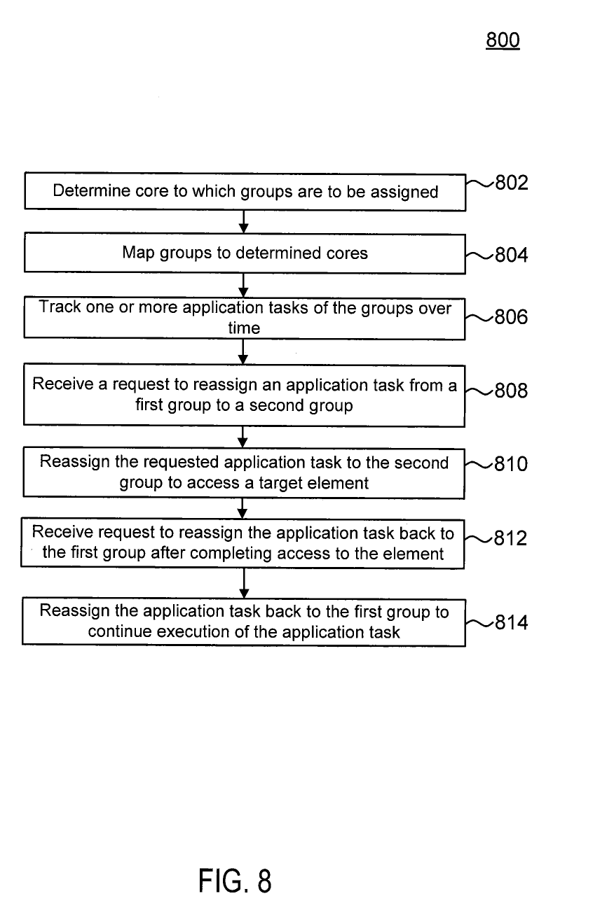

FIG. 8 is a flow diagram of an exemplary method 800 of initializing task core groups and temporarily reassigning application tasks between task core groups according to aspects of the present disclosure. The method 800 may be implemented by the storage controller 108 executing computer-readable instructions to perform the functions described herein in cooperation the rest of the storage system 102. It is understood that additional steps can be provided before, during, and after the steps of method 800, and that some of the steps described can be replaced or eliminated for other embodiments of the method 800.

At block 802, the storage controller 108 determines what core(s) task core groups are to be assigned, for example at system initialization as discussed with respect to block 508 of FIG. 5.

At block 804, the storage controller 108 maps the task core groups to their assigned core(s), for example as described with respect to block 510 of FIG. 5.

At block 806, the storage controller 108 tracks one or more application tasks, and one or more metrics of the cores on which they execute, over time, which may be used for dynamic rebalancing of task core groups, such as discussed above with respect to FIG. 5.

At block 808, the storage controller 108 receives a request to reassign an executing application task temporarily from a first task core group to a second task core group, so that the executing application task may access a target element (e.g., critical section of code/data structure) associated with the second task core group.

At block 810, the storage controller 108 reassigns the executing application task temporarily as requested so that the task may access the target element, for example as described above with respect to FIGS. 6, 7A, and 7B.

At block 812, the storage controller 108 receives a request to reassign the executing application task back to its original first task core group after the executing application task has completed access to the target element.

At block 814, the storage controller 108 reassigns the executing application task to the first task core group pursuant to the request at block 812, where the application task continues execution as applicable (and when scheduled), such as described above with respect to FIGS. 6, 7A, and 7B.

As a result, according to embodiments of the present disclosure selective multiprocessing is achieved which can provide a significant performance boost for storage controller products that have a limited time-to-market window. Embodiments of the present disclosure reduce the amount of code that must be modified to enable multiprocessing for an application by relating functional areas of code together into task core groups, which are assigned to specific cores in a multi-core (and/or multi-processor) system. Further, embodiments of the present disclosure provide a low overhead mutual exclusion method in a non-preemptive task scheduling environment, with less maintenance and faster time to market. The amount of contention associated with other mutual exclusion approaches is reduced, leading to yet further efficiencies at the processors/memories of the storage controller. Further, embodiments of the present disclosure may cause more CPU cache hits than conventionally occurs.

The present embodiments can take the form of an entirely hardware embodiment, an entirely software embodiment, or an embodiment containing both hardware and software elements. In that regard, in some embodiments, the computing system is programmable and is programmed to execute processes including those associated with the processes of methods 500, 700, 730, and/or 800 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method comprising:
determining, by a storage controller, a first designated central processing unit (CPU) core to which a first group of tasks is assigned for an application based on reliance on a first shared data structure associated with the first group of tasks, the first group of tasks comprising a first application task;
mapping, by the storage controller, the first group of tasks to the first designated CPU core based on the determination;
excluding, by the storage controller, access to the first shared data structure by a second application task grouped with a second group of tasks; and
tracking, by the storage controller, the application task of the first group of tasks over time, wherein application tasks within the first group of tasks are non-preemptive with respect to each other.

2. The method of claim 1, further comprising:
determining, by the storage controller, a second designated CPU core to which the second group of tasks is assigned for the application based on reliance on a second shared data structure associated with the second group of tasks; and
mapping, by the storage controller, the second group of tasks to the second designated CPU core based on the determination.

3. The method of claim 2, further comprising:
receiving, at the storage controller, a request from the first application task of the first group of tasks to be temporarily remapped to the second designated CPU core to which the second group of tasks is assigned so that the first application task may access the second shared data structure associated with the second group of tasks;
reassigning, by the storage controller, the first application task to the second group of tasks mapped to the second designated CPU core; and
scheduling, by a scheduler of the storage controller, the first application task on the second designated CPU core among one or more tasks associated with the second group of tasks.

4. The method claim 3, further comprising:
receiving, by the storage controller, an indication from the first application task of completion of at least one operation requiring access to the second shared data structure; and
reassigning, by the storage controller, the application task to the first group of tasks mapped to the first designated CPU core.

5. The method of claim 4, further comprising:
causing, by the storage controller, a second application task grouped with the first group of tasks to begin execution by the first designated CPU core in response to the first application task being temporarily reassigned to the second group of tasks mapped to the second designated CPU core; and
scheduling, by the scheduler of the storage controller, the first application task on the first designated CPU core to resume execution on the first designated CPU core after the completion of the at least one operation and after the second application task grouped with the first group of tasks completes execution.

6. The method of claim 1, further comprising:
measuring, by the storage controller, a performance metric for each of the first and second designated CPU cores based on the tracking; and
remapping, by the storage controller, the first group of tasks to the second designated CPU core in response to determining that the performance metric for the first designated CPU core is above a first threshold and the performance metric for the second designated CPU core is below a second threshold, or remapping, by the storage controller, the second group of tasks to the first designated CPU core in response to determining that the performance metric for the second designated CPU core is above the first threshold and the performance metric for the first designated CPU core is below the second threshold.

7. The method of claim 1, further comprising:
performing the determining, mapping, and tracking by a wrapper operating between the application and a scheduler for an operating system of the storage controller.

8. A computing device comprising:
a memory containing machine readable medium comprising machine executable code having stored thereon instructions for performing a method of multiprocessing and mutual exclusion in a non-preemptive tasking environment;
a processor coupled to the memory and comprising a plurality of central processing unit (CPU) cores, the processor configured to execute the machine executable code to cause the processor to:
determine a first CPU core to which a first core group is assigned that comprises a first plurality of tasks, based on reliance on a first shared data structure associated with the first core group;
determine a second CPU core to which a second core group is assigned that comprises a second plurality of tasks, based on reliance on a second shared data structure associated with the second core group, the first and second plurality of tasks being non-preemptive;
map the first core group to the first CPU core and the second core group to the second CPU core in response to the determination;
exclude access to the first shared data structure by the second plurality of tasks while assigned to the second core group and to the second shared data structure by the first plurality of tasks while assigned the first core group; and
temporarily reassign a running task from among the first plurality of tasks to the second core group mapped to the second CPU core to enable access by the running task to the second shared data structure associated with the second core group.

9. The computing device of claim 8, wherein the processor is further configured to execute the machine executable code to cause the processor to:
schedule, by a scheduler of the computing device, the running task on the second CPU core among the second plurality of tasks.

10. The computing device of claim 8, wherein the processor is further configured to execute the machine executable code to cause the processor to:
receive an indication from the running task of completion of at least one operation requiring access to the second shared data structure; and
reassign the running task to the first core group mapped to the first CPU core in response to receiving the indication.

11. The computing device of claim 8, wherein the processor is further configured to execute the machine executable code to cause the processor to:
cause a second task from among the first plurality of tasks to begin execution by the first CPU core in response to the running task being temporarily reassigned to the second core group mapped to the second CPU core; and
schedule, after the running task completes access to the second shared data structure, the running task on the first CPU core to continue execution on the first CPU core after the second task completes execution.

12. The computing device of claim 8, wherein the processor is further configured to execute the machine executable code to cause the processor to:
monitor a performance metric for each of the first and second CPU cores as one or more of the first and second plurality of tasks are executed; and
remap the first core group to the second CPU core in response to determining that the performance metric for the first CPU core is above a first threshold and the performance metric for the second CPU core is below a second threshold, or remap the second core group to the first CPU core in response to determining that the performance metric for the second CPU core is above the first threshold and the performance metric for the first CPU core is below the second threshold.

13. The computing device of claim of claim 8, wherein:
the first and second plurality of tasks comprise application tasks, and
the processor is further configured to execute the machine executable code to cause the processor to voluntarily allow preemption of the application tasks by one or more system tasks, the system tasks and the application tasks having access and control over different shared data structures.

14. The computing device of claim 8, wherein the processor is further configured to execute the machine executable code to cause the processor to:
perform the determination, mapping, and reassignment by a wrapper operating between an application to which one or more of the first and second plurality of tasks are associated with and a scheduler for an operating system of the computing system.

15. A non-transitory machine readable medium having stored thereon instructions for performing a method comprising machine executable code which when executed by at least one machine, causes the machine to:
map a first core group comprising a first plurality of tasks to a first central processing unit (CPU) core based on reliance on a first shared data structure associated with the first core group;
map a second core group comprising a second plurality of tasks to a second CPU core based on reliance on a second shared data structure associated with the second core group, the first and second plurality of tasks each being non-preemptive;
exclude access to the first shared data structure by the second plurality of tasks in response to the second plurality of tasks being assigned to the second core group, and to the second shared data structure by the first plurality of tasks in response to the first plurality of tasks being assigned to the first core group;
temporarily reassign a running task from among the first plurality of tasks to the second core group mapped to the second CPU core to enable access by the running task to the second shared data structure associated with the second core group; and
reassign the running task back to the first core group mapped to the first CPU core in response to receiving an indication of completion of at least one operation requiring access to the second shared data structure.

16. The non-transitory machine readable medium of claim 15, comprising further machine executable code which when executed by the at least one machine causes the machine to:
schedule the running task on the second CPU core among the second plurality of tasks in response to being temporarily reassigned to the second core group.

17. The non-transitory machine readable medium of claim 15, comprising further machine executable code which when executed by the at least one machine causes the machine to:
cause a second task from among the first plurality of tasks to begin execution by the first CPU core in response to the running task being temporarily reassigned to the second CPU core; and
schedule the running task on the first CPU core to continue execution on the first CPU core after the running task has been reassigned to the first core group and the second task completes execution.

18. The non-transitory machine readable medium of claim 15, comprising further machine executable code which when executed by the at least one machine causes the machine to:
monitor a performance metric for each of the first and second CPU cores as one or more of the first and second plurality of tasks are executed; and
remap the first core group to the second CPU core in response to determining that the performance metric for the first CPU core is above a first threshold and the performance metric for the second CPU core is below a second threshold, or remap the second core group to the first CPU core in response to determining that the performance metric for the second CPU core is above the first threshold and the performance metric for the first CPU core is below the second threshold.

19. The non-transitory machine readable medium of claim 15, wherein there are fewer CPU cores than core groups.

20. The non-transitory machine readable medium of claim 15, wherein the first and second plurality of tasks comprise application tasks, further comprising further machine executable code which when executed by the at least one machine causes the machine to:
voluntarily allow preemption of the application tasks by one or more system tasks, wherein the system tasks and the application tasks have access and control over different shared data structures than each other.
